(19) United States
(12) Patent Application Publication
(10) Pub. No.: US 2026/0368697 A1
(43) Pub. Date: Nov. 19, 2026

(54) METHOD AND SYSTEM FOR MANAGING FOOD SUPPLY PRODUCTION

(71) Applicant: SUFLEX TECNOLOGIA LTDA, São Paulo (BR)

(72) Inventor: Arthur Goldemberg, São Paulo (BR)

(21) Appl. No.: 19/637,608

(22) Filed: Apr. 2, 2026

Related U.S. Application Data
(63) Continuation of application No. PCT/BR2025/050281, filed on Jul. 2, 2025.

(30) Foreign Application Priority Data
Jul. 3, 2024 (BR) 1020240136993
Dec. 17, 2024 (BR) 1020240264762

(51) Int. Cl. G06Q 10/087; G06Q 30/018

(52) U.S. Cl. CPC G06Q 10/08776; G06Q 30/018

(57) ABSTRACT

The present invention relates to a method and a system for managing stock and expiration dates of food supplies produced in food production centers within food and nutrition units (“UANs”). Aiming to ensure regulatory compliance of UANs with ANVISA (the Brazilian FDA) guidelines and state and municipal health surveillance agencies, the system promotes efficiency in managing food production routines and also controls expiration dates, as it enables managers of said UANs to view on a single screen all the supplies that are open and in use in their establishments or locations where they provide food.

The present utility patent application claims internal priority of process BR 102024013699-3, filed on Jul. 3, 2024, under the terms of Law #9,279, of May 14, 1996.

### TECHNICAL FIELD

The present invention belongs to the field of systems or methods specially adapted for the purposes of managing resources and workflows related to the production and handling of food in food manufacturing centers-food and nutrition units (hereinafter, “UANs”).

### Introduction

The present invention relates to a system encompassing all routines, controls, and operations producing, storing, and handling food, including stock management, inventory management, stock pricing, receiving supplies with active quality monitoring, monitoring and controlling quantities, specifications, and temperatures upon receiving, controlling and managing production with interactive sizing and planning for production routines, managing purchases and stocking processes, managing operational tasks and monitoring of their execution, monitoring and tracking regulatory routine performance, and active monitoring and tracking of expiration dates stipulated in the health regulations for food supplies, with a view to food production.

### BACKGROUND

As is common knowledge, commercial activities involving products for human consumption, more specifically food and beverages in general, demand strict and careful control of storage conditions, handling methods, and product expiration dates, since they involve activities heavily regulated by state health surveillance agencies and specific legal systems.

Every UAN (Food and Nutrition Unit) needs to actively monitor the entry of supplies into its stock and strictly follow health legislation at the federal, state, and municipal levels. In this regulatory context, it is essential to guarantee the validity and traceability of supplies, especially in relation to their place of origin. This includes, e.g., animal products originating from duly registered centers and in compliance with the regulations of their respective sectors. Compliance is demonstrated through seals such as the SIF (Federal Inspection Service) or other equivalents, which certify the legitimate origin of food, even when regulated by other agencies. Food products made with inadequate supplies can cause serious harm to public health. Those responsible for handling or producing such inadequate foods are subject to administrative and, in some instances, criminal sanctions. With the increase in culinary production keeping pace with the growth of the world's population, so too is the demand for tools that facilitate the continuous monitoring of food safety.

Therefore, it is essential that those responsible for factories, restaurants, hotels, supermarkets, distributors, and other food production facilities, regardless of their size, have access to systems that can help better manage the various specificities that must be met. These systems aim to help ensure food quality by maintaining its quality until it reaches the consumer's table.

Furthermore, it is desirable that a system for managing food supply production also be capable of enabling measurement of efficiency gains in culinary production with visibility, traceability of supplies and possible waste reductions, enabling adequate visualization, increased control of the Cost of Goods Sold (“CMV”) and its consequent goal of reducing waste. Additionally, it is desirable that a system designed for the aforementioned purpose be capable to verify the regulatory compliance of UANs, using the normative guidelines of ANVISA (the Brazilian FDA) and local state and municipal health surveillance agencies.

Finally, it is desirable to have a management system that enables the managers of said UANs to actively manage their stocks, their purchasing and production processes, and the organization of expiration dates of food supplies that pass through their UANs in a simple, practical, friendly, and effective way.

### Prior Art

Known state-of-the-art solutions for management systems can be found in prior art documents such as IN20201103914, titled “A system and method for smart inventory management,” which, according to its abstract, refers to a system and method for managing end-to-end food stock for commercial kitchens, restaurants, or any fresh/ready-to-eat/packaged food manufacturing operations, with which it is possible to register the type and quantity of product received, track product movement from receipt to consumption, monitor its expiration date, and control stock levels. Such actions are carried out with the aid of cloud-based artificial intelligence technologies for identifying, authenticating, and estimating the quality and freshness of incoming food stock, both during consumption and for final food preparation. AI is also used to authenticate the operator through facial recognition and to acquire contactless measurements of different inventory parameters, such as weight, temperature, size, image, and gas emissions, simultaneously at various points.

However, it should be noted that such system requires specific equipment/compartment to place the received food products, in which there is a plurality of sensors (weight, image, temperature, among others) for acquiring the parameters, that is, it is a complex installation that demands significant physical space. With all these components, such system proves costly to implement and use, in addition to providing little practicality for small-scale UANs. Furthermore, if said equipment/compartment malfunctions, the use and effectiveness of the system are completely compromised, rendering it ineffective. Furthermore, said system does not provide means for monitoring and identifying the portioning of products, so the management ends up being incomplete and consequently inaccurate.

Another patent document whose solution can be mentioned is document U.S. Pat. No. 11,989,958, titled “Food storage system, method and computer readable medium,” which describes a system and method for sharing data about the contents of storage bags or containers with external devices, which can operate to track/record data about the contents in various storage bags and enable the identification of the contents in the storage bags based on a unique identifier associated with the storage bags. The system also employs artificial intelligence techniques to identify, through images of the packaging, shape, thickness, volume, and weight of the product—information that must later be confirmed by the user, otherwise the registers will be incorrect. However, said system also does not provide means to monitor and identify the portioning of products already registered when they are received from the supplier, which may compromise the accuracy of the inventory.

It is noted that the current state of the art is inherently subject to errors in filling, reading, and interpretation, both on the part of the employees and collaborators of UANs and on the part of the health surveillance or any agency responsible for health surveillance, which, in its role as regulator and supervisor of the sector, is capable of applying fines and carrying out closures that undermine the operation of UANs and generate irreparable damage to their reputation and the continuity of their business. Errors in supply management can cause immediate pecuniary and organizational damage, as they unfold into chains of errors. After an incorrect piece of data is input, the initial stock information compromises the entire subsequent (downstream) analysis chain, generating a succession of errors that will only end with the discovery of the root cause, but which may be noticed too late to avoid irreparable operational costs such as, for example, often unrecoverable financial losses that can lead to the closure of Food and Nutrition Units.

Still within the regulatory field, there are no products or patents aimed at generating lists that would ensure compliance and execution of tasks based on best practices and compliance with local health obligations (such as Standard Operating Procedures determined by ANVISA).

It should also be noted that, at kitchens of UANs focused on selling food to the general public or even for internal satisfaction, the following operational practices are, more or less consistently, considered as standard: (i) producing, identifying and portioning all mise en place (preparations); (ii) assembling sites (locations where handling and/or production is effectively carried out); (iii) monitoring the preparation/handling of final dishes and/or products; (iv) counting all processed and unprocessed supply stock; (v) expecting item replenishment for the next production sequence; and (vi) purchasing new supplies. Although such processes are followed by virtually all UANs, there is currently no systematized and widely disseminated methodology in this manner; instead, there is an unwritten and fragmented convention, without registered controls and with very little supervision. The absence of an integrated view of the supply flow within the production operation generates a series of problems and inefficiencies, including: (i) ineffective purchases (purchases of products that are currently valid and in stock); (ii) undersized or oversized productions; (iii) errors in the storage or use of products unfit for consumption (due to a lack of explicit information and clarification of their expiration dates).

Furthermore, the lack of a centralized inventory and supply quality and quantity make it difficult to calculate even a nominal value for CMV (Cost of Goods Sold). This difficulty leads to an increase, often unnoticed and lacking in informational sources, in the CMV of UANs. The impact on the profitability of UANs is immense and often only perceived when the situation regarding the sustainability of operations becomes uncontrollable and irremediable, leading to the closure of many UANs that depend on the sale of their products to continue operating, such as restaurants, hotels, production kitchens, and the recently developed “ghost kitchens” (dark kitchens). Furthermore, UANs face several operational difficulties, such as a lack of materials for proper tagging (heat-resistant tags and filling instruments). It is common for information to be lost or misplaced in the kitchen, whether due to a lack of centralization or the loss of reference documents. The spreadsheets are printed and then filled out manually. And lastly, the time spent by employees on decentralized monitoring and tagging tasks, which could be dedicated to the UAN's core activity, is significant in relation to other tasks. Added to this is the low qualifications of the employees, aggravated by the chronic problem of illiteracy and functional illiteracy, and the errors generated in said spreadsheets as a result of this situation. The challenging kitchen environment, with its tensions and frictions common in professional operations, also impacts workflow. All these difficulties are reflected in the lack of visibility of the updated stock, since control processes are mostly manual and quite obsolete, especially in monitoring expiration dates, and are subject to frequent filling and control errors.

Finally, the systems known in the art do not have any type of interconnection or interface with the suppliers of the products employed in the UANs.

Therefore, there is room for a method and system for managing food supply production, which:
a) Are integrated. Enable kitchen managers to have a comprehensive view of the entire operational and workflow, and of the supply flows in the UAN. That is, from receiving after purchase, through the portioning and handling process, and finally, to the production and forwarding of the final product to the consumer at the end of the chain;
b) Enable preventing and mitigating operational errors throughout the production chain of food and nutrition units;
c) Provide centralized mechanisms with adequate visibility to identify the quantities and pecuniary value of the stock of supplies that will be forwarded to production; and during the production process;
d) Enable monitoring expiration dates and managing the receipt of supplies at the UAN, with effective stock counting, enabling UAN managers to plan their production and, eventually, provide information to UAN controllers regarding the control and purchase of supplies to better supply the UAN and efficiently fulfill the production plan;
e) Are able to monitor and ensure regulatory compliance of UANs in relation to guidelines from ANVISA and local state and municipal health surveillance agencies;
f) Track the supply from the moment it enters the kitchen through its transformation process and delivery to the end consumer, and
g) Interface with suppliers to facilitate the purchasing process for replenishing missing products.

### Objects of the Invention

The objective of the invention is, therefore, to provide system for managing food supply production for food and nutrition units according to the characteristics of claim 1 of the attached set of claims.

Another objective of the invention is to provide a method for managing food supply production according to the characteristics of claim 6 of the attached set of claims.

Additional characteristics and details of the characteristics are represented in the dependent claims.

### DESCRIPTION OF THE DRAWINGS

For a better understanding and visualization of the subject matter of the present invention, it will now be described with reference to the appended drawings, which illustrate the technical effect obtained by means of an exemplary embodiment that is not limiting to the scope of the present invention, in which, schematically:

FIG. 1: presents an illustration of the kitchen routine that the system of the present invention encompasses;

FIG. 2: presents a detailed illustrative diagram of a kitchen's production routine, in which the inner wheel indicates the platform's interface points against the external wheel that details the broader kitchen routine;

FIG. 3: shows views of the user interface screens on a mobile device, displaying the navigation menu and engagement cards;

FIG. 4: displays the screen from FIG. 3, enabling a detailed view of the pecuniary value indicators of products in stock nearing their expiration date;

FIG. 5: shows the system screen when viewed on a desktop;

FIG. 6: shows the system screen when viewed on a tablet;

FIG. 7: shows another system screen when viewed on a tablet;

FIG. 8: shows a visual representation of a tag printed by the system, without a QR Code;

FIG. 9: shows a visual representation of a tag printed by the system, with a QR Code;

FIG. 10: shows a part of a flowchart illustrating the steps of food management control in the system of the present invention, illustrating the order receipt step;

FIG. 11: shows another part of the flowchart, illustrating the purchasing step;

FIG. 12: shows another part of the flowchart, illustrating a step of sending the generated list;

FIG. 13: shows another part of the flowchart, illustrating a product counting step;

FIG. 14: shows another part of the flowchart, illustrating the dashboard step;

FIG. 15: shows another part of the flowchart, illustrating the stock management step;

FIG. 16: shows another part of the flowchart, illustrating a food production step;

FIG. 17: shows another part of the flowchart, illustrating a product selection step;

FIG. 18: shows another part of the flowchart, illustrating a group selection step;

FIG. 19: shows another part of the flowchart, illustrating a step of selecting food for group printing; and FIG. 20: shows another part of the flowchart, illustrating a product interface step.

FIG. 21: displays the mobile application view on the “home page” options menu screen;

FIG. 22: displays the mobile application view on the “home page” screen;

FIG. 23: displays the mobile application view on the registration screen;

FIG. 24: displays the mobile application view on the groups and subgroups screen;

FIG. 25: displays the mobile application view on the pre-print tag template screen;

FIG. 26: displays the desktop application view on the tag group printing screen;

FIG. 27: displays the mobile application view on the expiration date monitoring screen;

FIG. 28: displays the mobile application view on the QR Code data reading screen for monitoring expiration dates;

FIG. 29: displays the mobile application view on the product counting flow screen;

FIG. 30: displays the view of the tablet application on the stock control screen;

FIG. 31: displays the mobile application view on the supply control screen;

FIG. 32: displays the mobile application view on the receipt control screen;

FIG. 33: displays another mobile application view on the supply control screen; and

FIG. 34: displays the first part of a flowchart of the method for using the management system of the present invention; and

FIG. 35: displays the second part of the flowchart presented in FIG. 34.

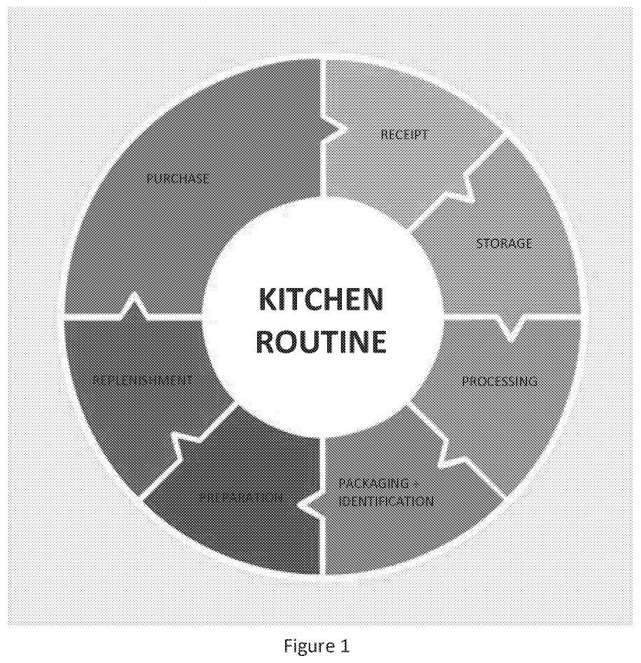

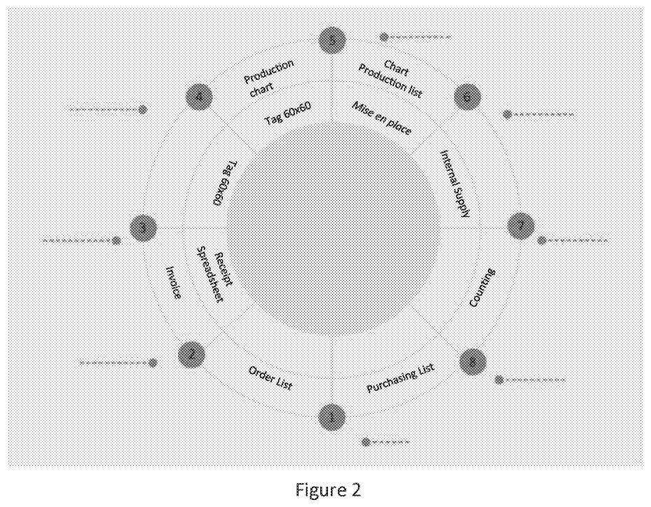

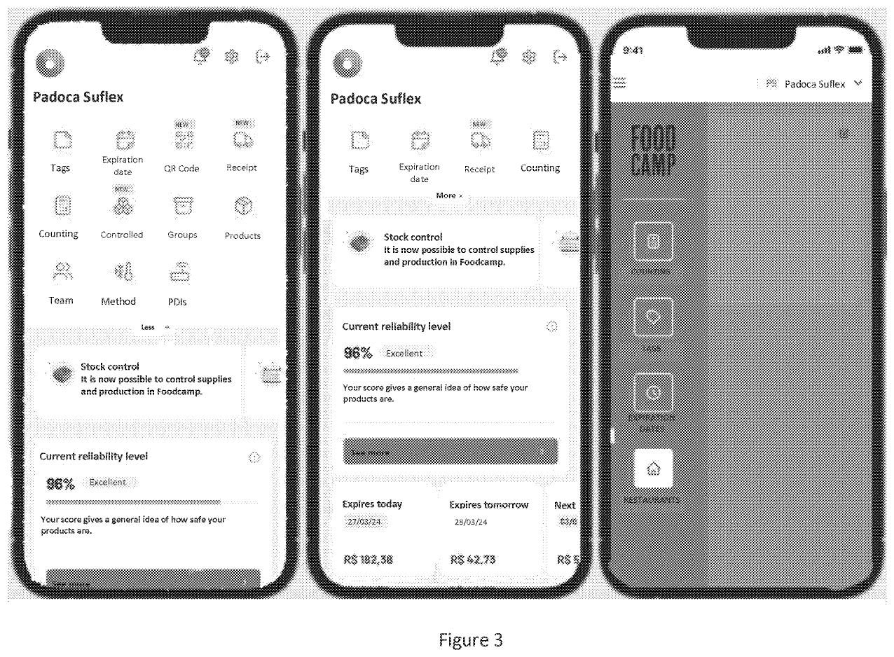

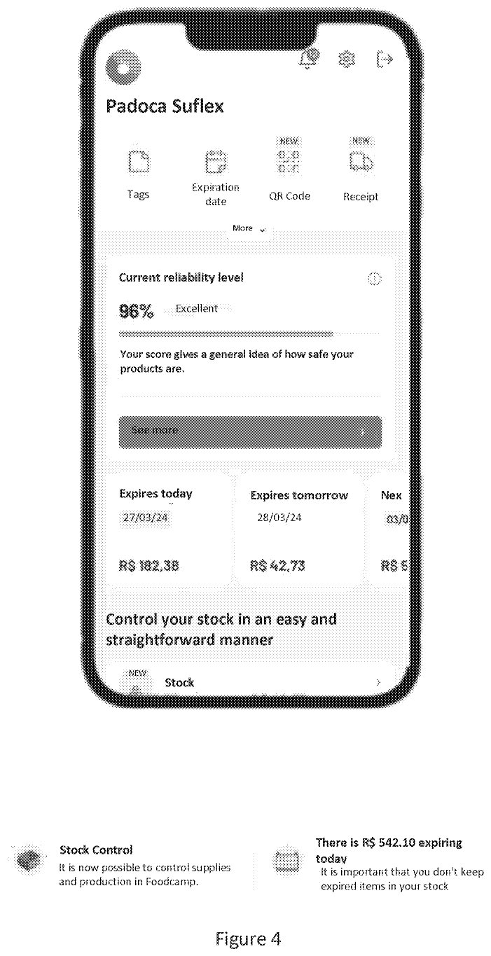

### DETAILED DESCRIPTION OF THE INVENTION

The following detailed description refers to the appended drawings in which, by way of non-limiting illustration, embodiments of the present invention are represented. These embodiments are described so as to enable a person skilled in the art to reproduce the results. Other embodiments resulting from visual aesthetic changes are possible and can be carried out without departing from the spirit and scope of the present invention. The following detailed description should therefore not be understood in a restrictive or limiting manner.

according to the present invention comprises a solution consisting of a software or application for use on at least one electronic device, which may be a microcomputer (such as Raspberry PI 4 and/or the like), a mobile device (cell phone and tablet), or a static device (personal computer), wherein such software or application connects, remotely or via wire, to a printer so that the user can print tags for tagging the food supplies to be managed. The system also comprises at least one image capture device cooperating with said electronic device, wherein the image capture device may be a camera embedded in a tablet, cell phone, or personal computer.

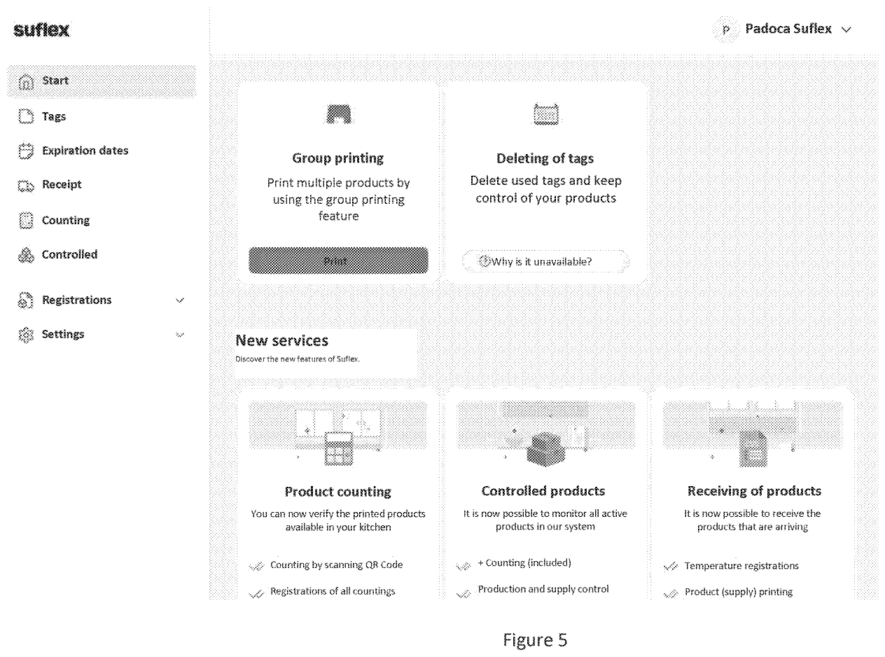

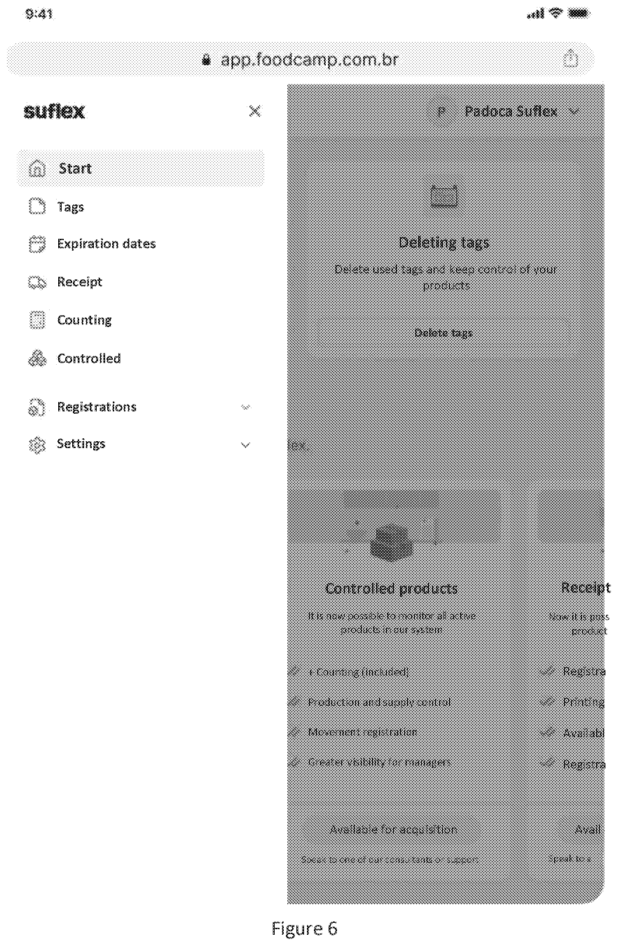

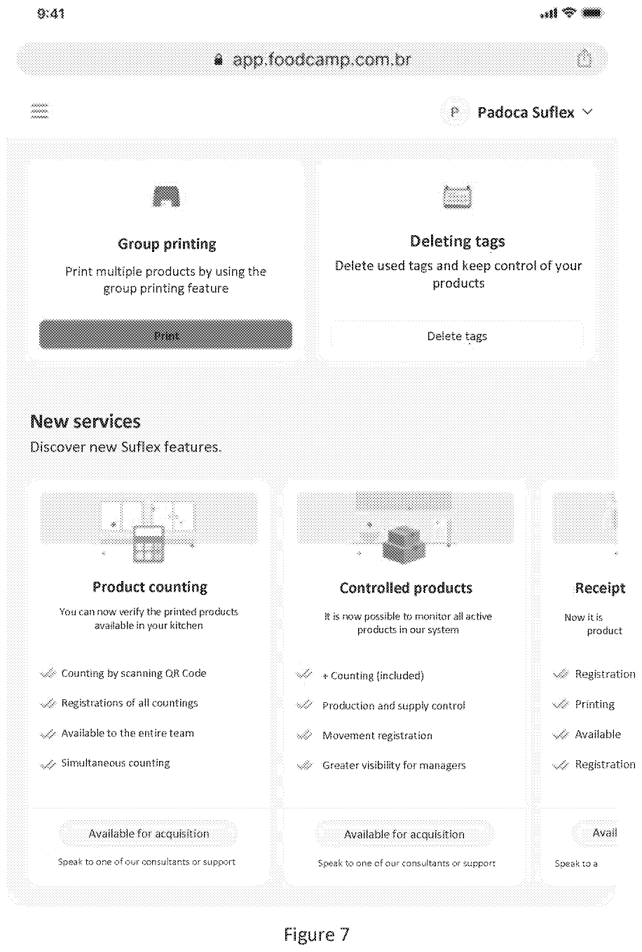

The system is web-based, accessible via mobile devices and computers, and sends and receives information packets directly to the server where the software is installed, wherein at least one information packet provides information that enables the system to check whether food supplies are complying with local regulatory and health obligations. All the system's information base and its database are stored in a digital cloud. Given the possibility of versatile use in several types of systems, two distinct types of users are created: the manager (or stakeholder) responsible for the financial and operational management of the stock; and the functional user, who works in the kitchen and will be responsible for both the first interface with the receiving process and the tagging process, both of which are detailed further below. As a rule, the manager will have a broader view of the system (FIG. 5), while the user will have a more condensed view aligned with the functions they will perform.

The system of the present invention also makes it possible to create different manager profiles for each type of manager in the kitchen, e.g., managers who are only responsible for certain sites, or managers who are only responsible for monitoring alcoholic beverages. In addition, the system also meets the monitoring needs of nutritionists and technicians of restaurants (CFN Rule #378/2005 and #576/2016), whether said nutritionists work exclusively for one UAN or several. In this last case, the user (whether a nutritionist or not) will be able to have several accesses across different restaurants, centralizing their ability to monitor all the restaurants they are responsible for in a single interface. For this purpose, each user is provided with a combination of identifier (login) and keyword (password) to access the system.

When starting to use the system of the present invention, it is necessary to map all the supplies used in the kitchen so that it is possible to discriminate the stock base that will later be fed by the user, as well as the expiration dates determined by current regulations (RDC Anvisa #216/04 and regulations at the state and municipal level, such as CVS #5/SP) for the expiration date management module.

The system enables traceability from entry to exit of the supplies by creating, in the software, monitoring tags, printing them, fixing them to the supplies, and tracking, by the software, such supplies based on said tags. Mapping supplies, in short, means actively monitoring the supply from its entry into the kitchen, its handling and fractionating, and finally, its exit to the production site, a moment embodied in the act of indicating in the system that the supply has been used and is no longer part of the stock (referred to later herein as the act of “removing” a supply registered in the stock) in the supply in the kitchen. The data are stored natively in the system presented herein and in a cloud computing system, therefore having backups or registers that can be accessed. At an operational point, product registration is carried out by the user upon receiving the supply in the kitchen, by inputting some essential information into the system, such as the product name, its brand, its Federal Inspection Seal (SIF) number, batch number, and its temperature at the time of receipt (in line with regulatory guidelines on product receipt). In this registration process, it is also possible to check the authenticity of the SIF/LOTE based on the registrations of ANVISA and the respective ministries responsible for each food item that is reconciled upon entering the kitchen. In this respect, it is important to highlight that the system of the present invention is linked to the regulations and databases of the health surveillance services of the place of use in order to also check whether the conditions of receipt and storage comply with the determinations of the regulatory agency for such supply.

The system user also receives an access key that enables the subsequent inclusion of additional supplies. The software certainly keeps a register of the actions carried out within each access key, enabling a chain of control, that is, storing a history of all actions taken. Such control chain is stored natively in the system software (and backed up in the abovementioned cloud computing) and is only accessible via manager login. Access to said control chain enables one to see, in context, how many printouts and deletions were carried out, and what processes were carried out in the kitchen during a specific time interval or at a specific time.

After the initial registration of supplies, the user gains access to a control panel through which it is possible to manage and monitor the supplies. Said control panel has the following features: (i) Expiration Dates; (ii) Filters and Search; (iii) Validity Status; (iv) Change History; (v) Person in charge of platform customizations and handling; and (vi) Graphs, Usage Statistics, best practice suggestions and Data Analysis. On screen, there is a set of organized data that translates into efficiency gains not only for the food production sector of the kitchen and its compliance with legal and sub-legal regulations, but also for the performance of supply and planning processes in this sector.

In short, the platform enables for the consolidation, centralization, and use of data related to the supplies handled in the kitchen for the following activities: (i) regulatory compliance, through printing, tagging and comparison between the storage conditions of the supply and the regulatory requirements of the health surveillance agencies for the correct storage of such supply; (ii) planning and performance of purchasing and supply processes for supplies so that the abovementioned production process is performed with efficiency gains and waste reduction; (iii) culinary production planning, through analysis and use of the production control module; and (iv) performance of controls in the supply receiving process, since the tool serves as a source of information control.

Regarding the regulatory compliance outlined in item (i) above: the tool carries out tag printing directly through the system and its data monitoring. The user fills in the data related to the supply at the time of its receipt (its weight, its SIF/LOTE identification, the supplier's identification, and the identification of the person/employee in the kitchen who received the supply) within the system, whether on a cell phone, tablet, or microcomputer, and sends the tag for printing on the printer via the interface itself, using a wireless data transmission system, or via wire connection between the tablet or microcomputer and the printer. Alternatively, the user may use the tag's data input field to perform other functions (such as fulfilling regulatory compliance tasks detailed below) for internal control purposes, executing functions that go beyond managing expiration dates in their UAN.

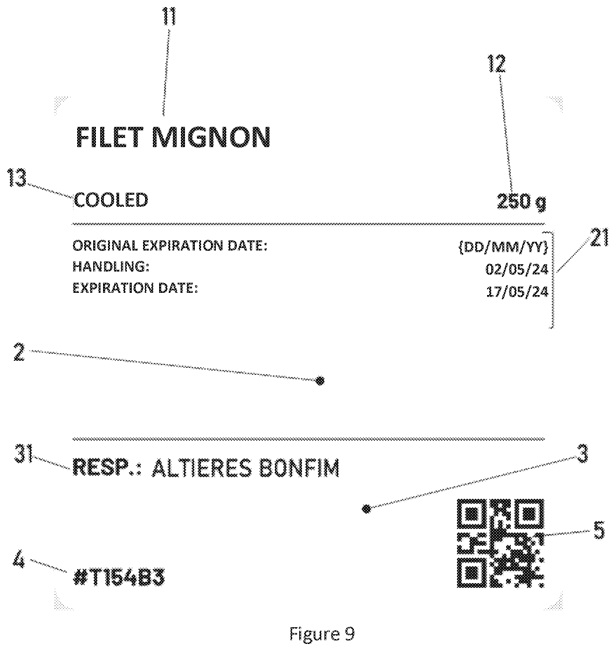

At the time of printing, the user can modulate the tag based on the following parameters: (i) size; wherein, in one exemplary embodiment of the present invention, tags measuring 60 millimeters by 60 millimeters or 40 millimeters by 25 millimeters are used; (ii) additional information which may include: the UAN logo or visual identification (e.g., restaurant logo, company name associated with the industrial kitchen, etc.); information about the legal entity that owns and is responsible for the UAN (e.g., the Corporate Taxpayers Register number and/or address of the food and nutrition unit). Such tag may contain a readable code (5) (barcode or QR Code; see FIG. 9), which can be scanned by a device with a camera, such as a tablet or cell phone, and the system will promptly recognize the supply and show the product information and unique number referring to that tag. The system will recognize and provide the user with information that may not be present on the physical printed tag, but which was input by the user during the registration and creation of that specific tag, as detailed in the following paragraph. Alternatively to scanning the reading code (5), the system also enables the use of “RFID” (Radiofrequency Identification) technology. In this embodiment, the tags will be printed with chips that will allow the use of technology enabling a user, equipped with a hand-held RFID reader (radioscanner), to pass this reader over their physical stock so that the system can identify and recognize all the supply base present therein. This is another suitable source of information to perform planning and control. The tool is also capable of generating tags to comply with sector regulations pertaining to food tagging, specifically the ones contained in Article 30 of CVS Ordinance #5 of Apr. 9, 2013, issued by the São Paulo State Department of Health-Health Surveillance Center, and sector regulations and related rules issued by state-level health surveillance agencies.

At this point, it is worth noting that the tag on screen represents a data organization element whose organizational methodology is unprecedented to date. For creating such tag, Gestalt principles and the pragnanz of form were considered, along with the hierarchy of information, where typographic weights were strategically organized to group and structure the tag's information efficiently. In addition, visual design principles were applied to optimize readability and functionality. Specifically, the following Gestalt principles were used: the Principle of Common Region, where elements tend to be perceived as groups if they share an area with a clearly defined boundary; the Principle of Proximity, where objects close to each other tend to be grouped together; the Principle of Pragnanz, where people viewing the artifact will perceive and interpret ambiguous or complex images in the simplest way possible, as this interpretation requires the least cognitive effort; the Principle of Similarity, where the human eye tends to perceive similar elements in a design as a complete image, shape, or group, even if those elements are separate; and the Principle of Uniform Connectedness, where elements that are visually connected are perceived as more related than elements without connection. Such principles were carefully applied to ensure that the tag is aesthetically pleasing, as well as highly functional and easy to understand.

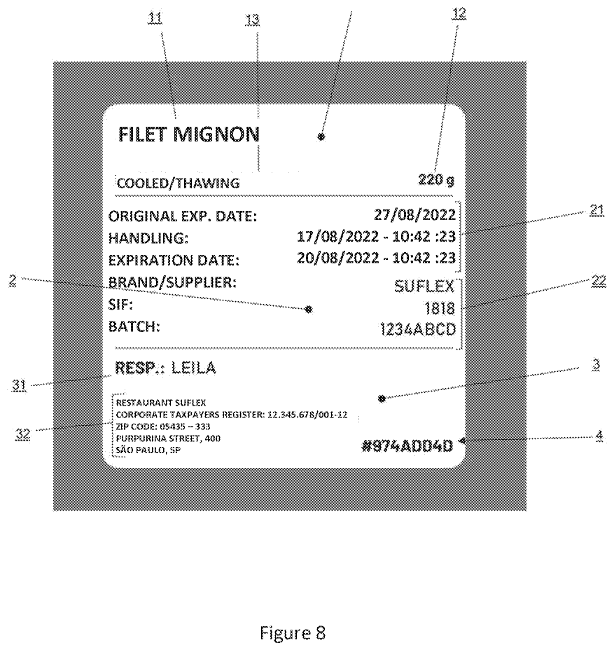

Referring to FIG. 8, the tag is separated into four main sections (1, 2, 3, and 4), each with specific design characteristics as indicated below.

Section (1) is the first to be noticed by the user, facilitating quick product identification, and presents the product name (11), the measurement unit (12), and the storage condition (13). Preferably the product name (11) is displayed in sans-serif font, large size and bold to ensure visibility and quick identification. The measurement unit (12) indicates supply weight, quantity or volume, displayed in sans-serif font, smaller and in bold, creating emphasis. The storage condition (13) which, for example, may have the terms “cooled”, “frozen”, “room temperature” or “hot”, is presented in smaller font, just below the product name, highlighting the product storage condition.

Section (2), located in the middle region of the tag, presents the properties for CVS-5 compliance, aiming to comply with the most critical legislation in this context, as well as indicating some additional information. It indicates the Original Expiry Date, Handling Date, and Expiry Date (21), presented in a medium-sized font, bold, left-aligned for easy sequential reading, with dates in day/month/year and hour: minute: second format for accuracy. It also indicates supply Brand, Supplier, SIF and Batch (22), highlighted in bold, with the separation of lines and the spacing between each item using the white space technique, ensuring visual clarity and preventing information clutter.

Section (3), located in the lower region of the tag, indicates the responsible (31) user and the business information (32) of the UAN. The Responsible (31) indication is highlighted in bold, indicating the person responsible for handling the product; this information is not mandatory, but it is considered a good practice and helps improve the continuous efficiency process to ensure specific user training. Since this information changes from tag to tag, it was given the same typographic weight as the fields in section (2). The business information (32) indicates the name of the restaurant or UAN, Corporate Taxpayers Register number, address and ZIP code, organized hierarchically and aligned to the left. The Corporate Taxpayers Register and ZIP code are placed side-by-side due to the character size standard, enabling control over the field width, thus ensuring that the address (variable in character length) occupies a full line, avoiding typographical overlap. City and State: Located below the address.

Finally, section (4) refers to the product identifier number, and is positioned in the lower right corner, in bold and preceded by a hashtag symbol (#), generated by a unique system algorithm. This alphanumeric identifier ensures a unique and global identification, connecting the physical tag to the digital management system of the present invention.

Within the present management system, the data input into tags also perform the execution control function of routine regulatory compliance tasks, such as those detailed in ANVISA's standard operating procedures. Although the printed tag is the final product, it is also possible to view additional data in the system interface that may or may not effectively be printed. In this way, it is possible to check if there are registers that the UAN team has properly executed tasks such as, e.g., cleaning hoods in the kitchen, changing air conditioning filters in environments where products are served directly to end consumers, or even if the fire extinguishers are valid. Naturally, it is possible to tag the environments where such tasks are performed if, within the UAN production environments,—taking the replacement of the hood as an example—a UAN manager chooses to print tags indicating the need for replacement, indicating the day and time the task was executed, and subsequently monitor the routine of completing this task by viewing the history of data input and even the printing of tags related to this completion. Through this static digitization, the system also enables impartial checking by health inspection agencies, which can access the chain of data input and have access to an additional source of proof of effective compliance with standard operating procedures, in a market where falsification of this data is a recurring practice.

Printed or virtual tags (viewable through the interface) equipped with reading codes enable access to the aforementioned database, through which users can view and update data related to food supplies in real time. Even after printing, creating, and/or applying tags to supplies, all linked information can still be modified and updated on the digital platform, reflecting any and all changes carried out in real time. This feature ensures that critical data about the supplies-such as expiry dates, storage conditions, current processing status are always up to date and accessible by reading the reading code (5) present on the tags. This approach not only generates considerable efficiency gains in stock control and supply management, but also contributes to better regulatory compliance and complements the supply tracking functionality throughout the entire food production chain in the methodology presented herein.

Beyond what has been explained regarding tagging and its role not only as a data artifact to identify the transit of supplies in the kitchen, but also for fulfilling regulatory tasks, the system is also capable of providing information regarding the waste rate during the handling and production process. As supplies are handled to execute final dishes (e.g., a fish fillet to be served, a vegetable to be handled, and foods that tend to lose some of their weight due to water variations during handling), the user is able to indicate which components of that supply are actually discarded out of necessity (e.g., the fish bone or the vegetable peel) and which are discarded for each production process and could eventually be reused in other processes (e.g., fish tail and skin that could be used as a supply in a tail that would be used in another dish, vegetable peel and/or unused parts that can be used to generate a tail). With each iteration and instantiated manipulation process, the system acquires new datasets capable of indicating which components are used in each manipulation process and their characteristics that lead to waste or loss of composition, and indicating a correction factor for future development of manipulation processes. This factor is further correlated with the component concerning the suggestion of routine purchases through continuous analysis of supplies that usually lose part of their grammage and composition during the handling process, such as animal or vegetable proteins with high water density.

Regarding the planning and performance of purchasing and supply processes, in the first instance of using the system, the user will be able to register their entire current supply stock, without compromising future additions and inclusions of supplies based on the receiving step described below. This process, in itself, immediately provides centralization and visualization of information that was previously fragmented and spread across several different databases. This mapping process is vital for the proper use of the system and, more importantly, for the effective performance of the kitchen's operational routine. There is an entire nutritional consulting industry that takes, as a starting point in its consulting processes, precisely the mapping of the supply base present in a UAN. The use of the system of the present invention enables this process to be carried out solely by the user, who then has complete control over the data they input. The system will carry out this initial registration and mapping process using artificial intelligence, which will analyze a photo of an artifact that comprises all the final products generated by the UAN (for example, in the case of restaurants, menus or, in the case of industrial kitchens, brochures that indicate all the items that are produced) and compile all the supplies necessary for the production of such list. Alternatively, this mapping can also be carried out through voice recognition (audio) that describes all the supplies currently in stock (in this case, the user speaks to the application, which, based on what was said, will map what was said and build the mapping as a list).

The system will also provide purchase suggestions based on the user's purchase and stock history. The system will indicate: (i) types and quantities of supplies that need to be acquired; and (ii) suppliers qualified to purchase the aforementioned items, both items taking into account the current quantity in stock of each supply. The system uses the following parameters for this process: the data obtained from the quantification and qualification of each supply upon its arrival in the stock, through its tagging, since each tag upon receipt will include the date of arrival of the supply, its weight, its SIF/LOTE identification, the supplier's identification, and the identification of the person/employee in the kitchen who received the supply (“Products Received”). When registering a supply in the “Products Received” field, the system will provide, in accordance with regulatory requirements, a field to indicate the temperature at which the supply was received, which the user will then inform/input. At this same moment of registration, it is also possible to input additional information into the system that is not on the printed tag and that can later be consulted by the user when capturing the reading code (5) which, in a preferred embodiment of the invention, could be scanning via digital camera.

The system will then create a receipt history taking into account said data, which can be consulted against the purchasing list (which the system will also generate, as will be detailed below) for immediate internal validation and will become part of the data mesh related to the kitchen of that UAN.

From the start of the handling process, the system will be able to indicate, based on the metrics obtained in the previous item, how much each supply will yield of specific products (for example: when the UAN receives a whole chicken, the system will be able to predict the transformation of this chicken into fractionated supplies and quantify the production based on each fractionated supply, such as thigh, breast, and wing).

Regarding the culinary production planning identified in item (iii) above: once the receiving process and verification of the items received against the purchasing list have been done, the kitchen will begin to handle the supplies for its production. From the moment a supply is handled, a new tag is obligatorily generated with a unique identifier (hash) that enables the subsequent tracking of that specific supply as it moves through the production process. Using the example of the chicken received in the previous item, each component of the chicken will now receive its own tag (thigh, drumstick, breast, etc.), and everything that is effectively handled/portioned will become part of the “Controlled Products” mesh. Following the example, when the chicken is portioned, the user will remove the whole chicken and then generate tags for each component/portion. The system will then use the data relating to the “Product Received” in the previous item to understand its transformation process: whether the product's temperature changed (for example, through thawing) and whether it was fractionated. This supply is then forwarded to the appropriate site for conversion into a final product: for example, chicken thighs are marinated and served to the end consumer. After using it, the user will remove this component from the mesh. This process is facilitated by using the reading code (5) that is printed on the tag (depending on the choice of the manager or user responsible for handling it when it was originally tagged).

In summary, the process begins with the receipt of the supply in the kitchen's stock (“Product Received”) and its verification against the purchase list (either from the platform itself or from the buyer responsible for the stock) through a first tagging process; the conversion of the supply for handling in the kitchen (fractionating and changing the supply to make it suitable for cooking), which may or may not have a second tagging; and finally, the removal of the supply in stock when it is converted into a final product.

It is important to point out that there are several products that are not fractionated/divided upon receipt, and that go directly from receipt to the final stage of production. Consider, for example, a filet mignon that is received in a quantity that is already suitable for final production and will not need to be fractionated or portioned for its production process. In addition to products intended for the end consumer, the system also tracks potential waste on the platform through expiration date control-items that are no longer suitable for consumption, given that they are no longer within their expiration date.

Given the extensive data mesh produced from the abovementioned processes, the following occur: the system will generate reports on the pecuniary value of each supply within the stock, resulting in a complete overview of the stock in pecuniary terms. Based on this piece of data, the system will be able to generate reports related to the consumption of the UAN within time periods, suggesting what should be produced and, consequently, what should be purchased to integrate into the stock for future production cycles. As a result of the data obtained in the processes described above, the system will be able to generate a purchase list, either manually (with data entered by the user) or through internal system iteration based on datasets or production processes.

In addition to the above, the system of the present invention is also capable of generating a “reliability index” regarding the data available in the kitchen, which is based on user interactions. The more precise and consistent the user interactions with the system are, the better the reliability index of the data stored within it. This process brings gains both to the user, who has greater confidence and accurate and assertive data on their platform, and to the system itself, which receives this accurate data and is able to refine its iterations and generate more precise data in line with the reality of the UAN.

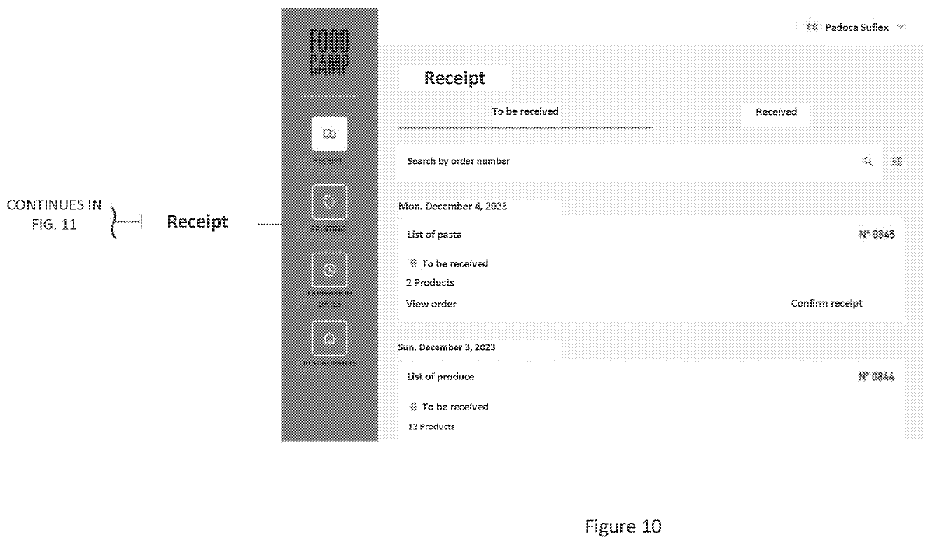

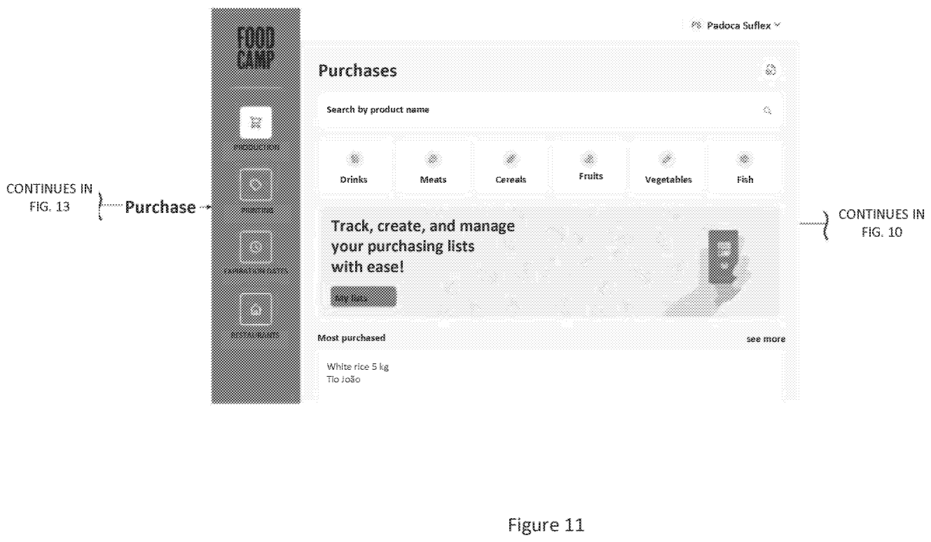

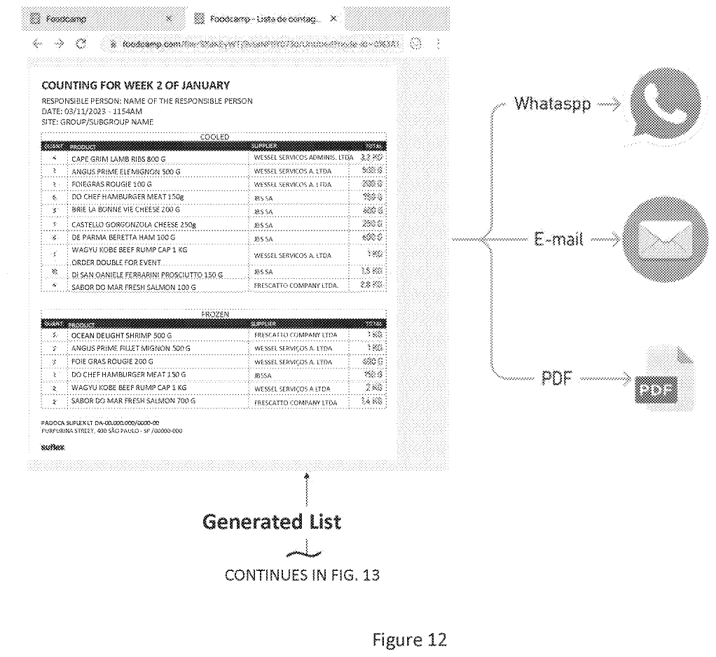

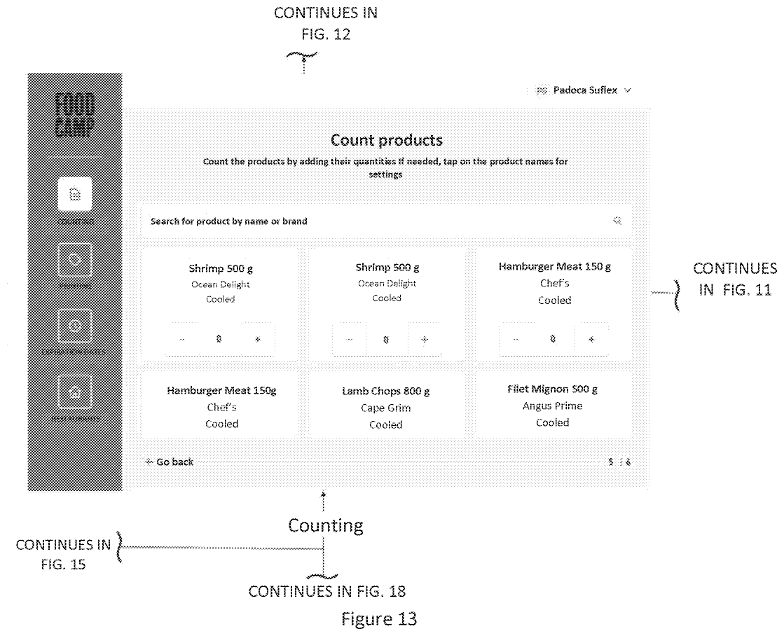

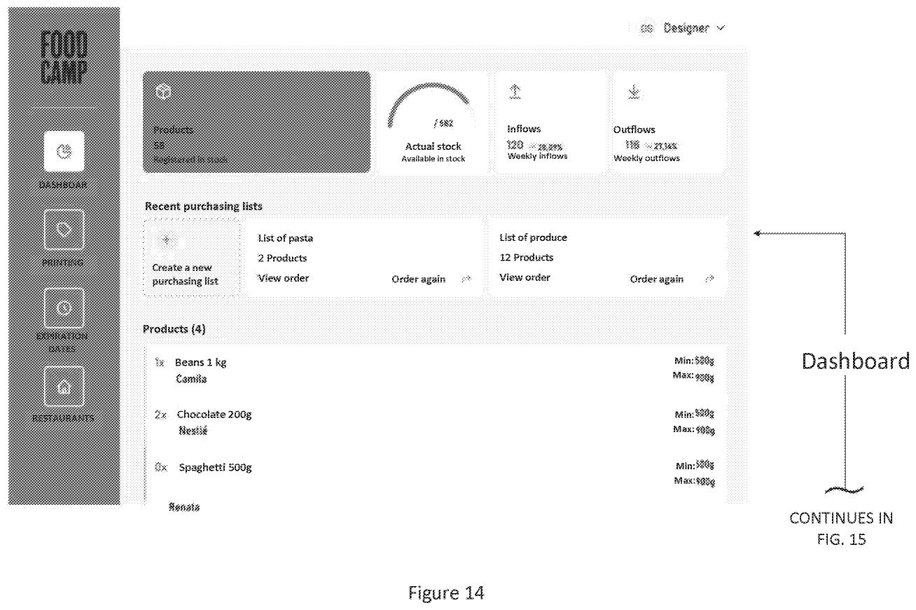

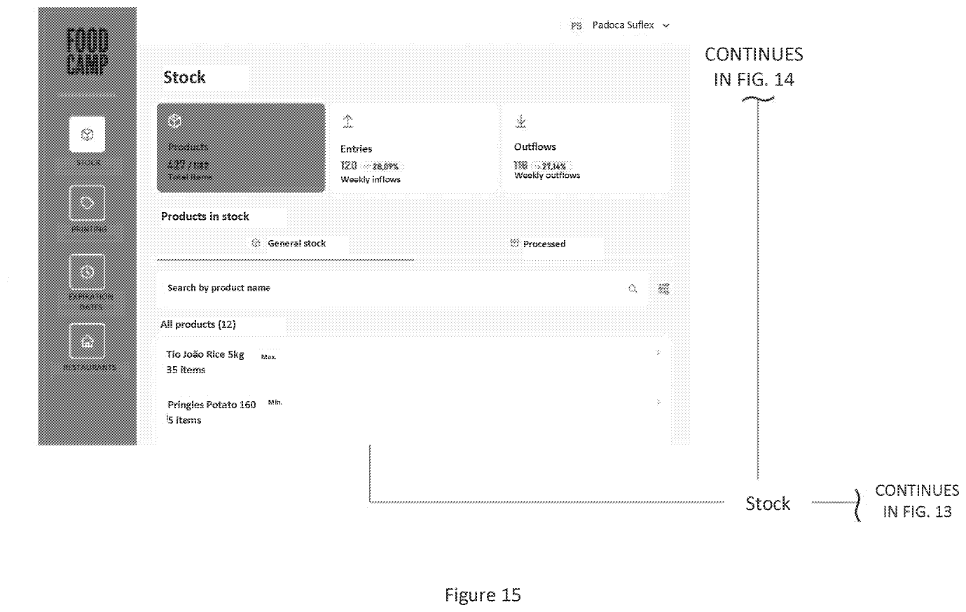

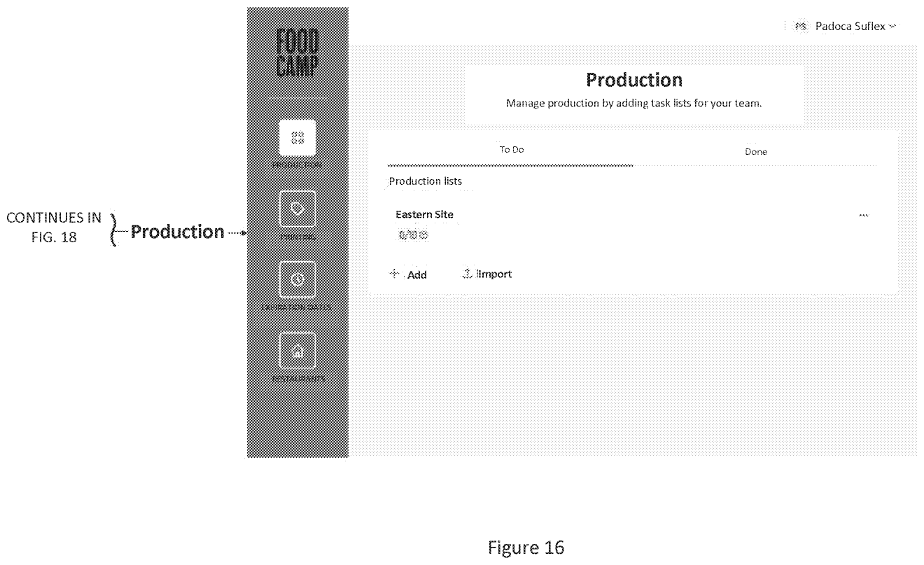

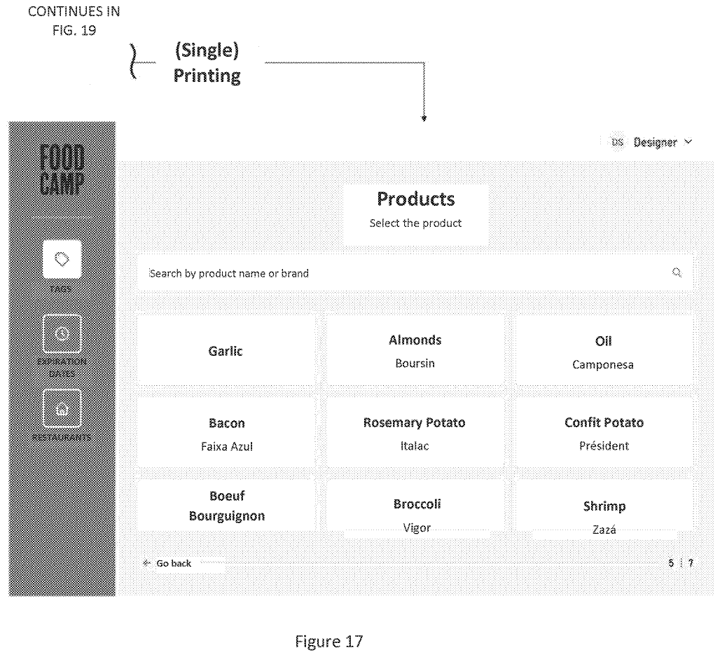

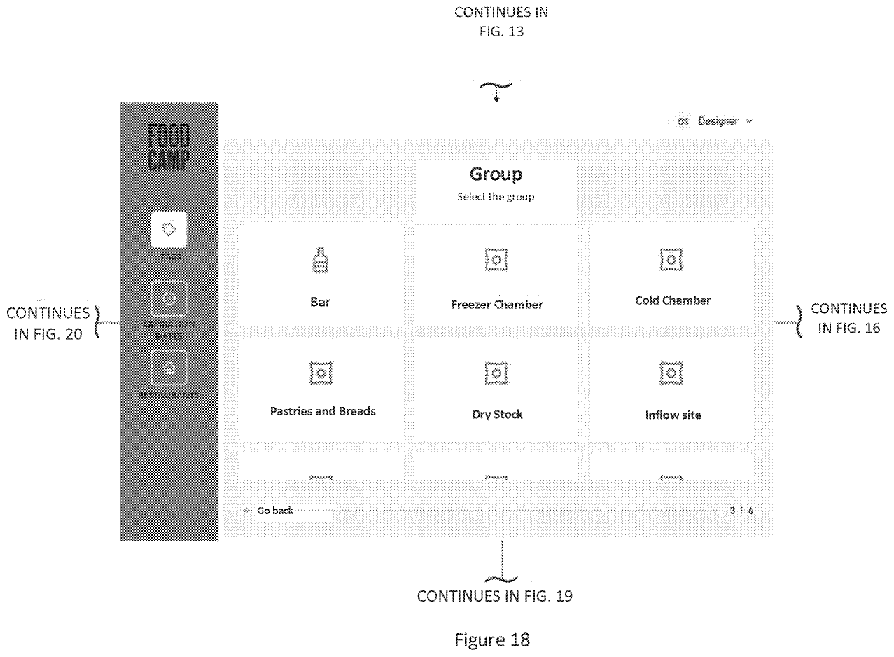

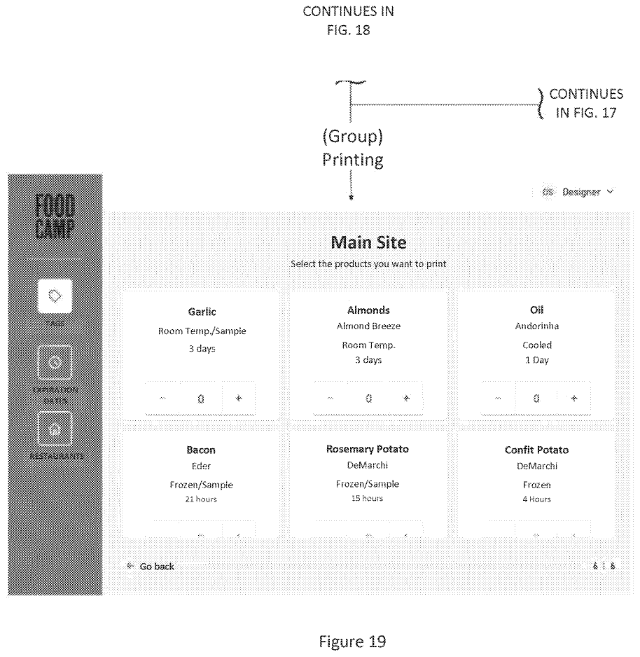

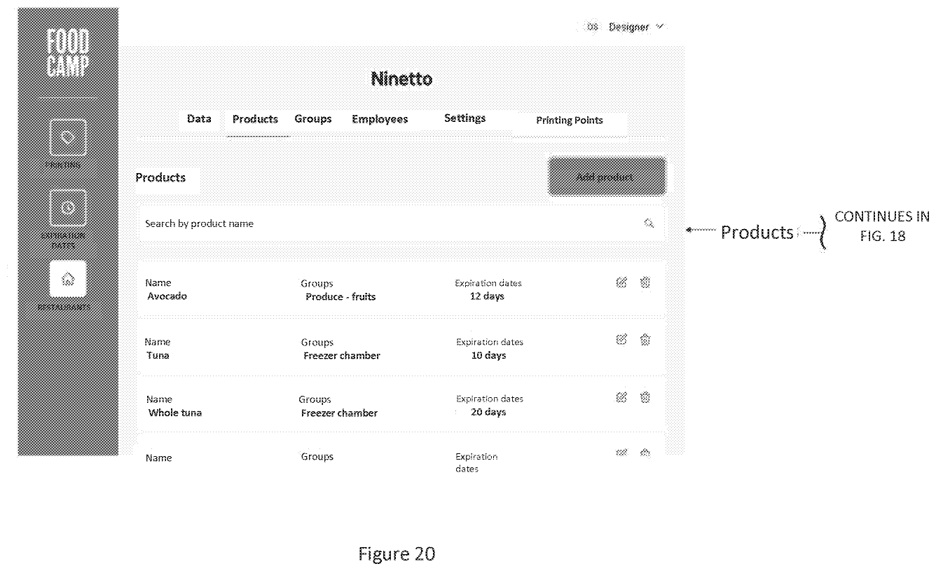

FIGS. 10 to 20 display a flowchart of said system's usage, with its constituent steps detailed as described below.

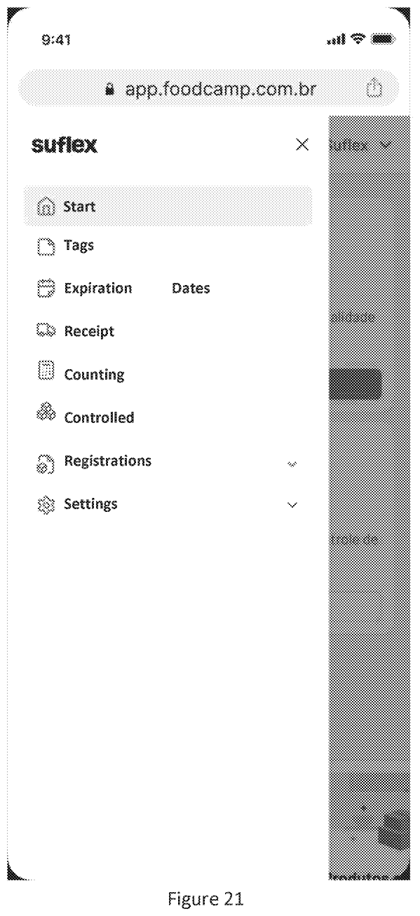

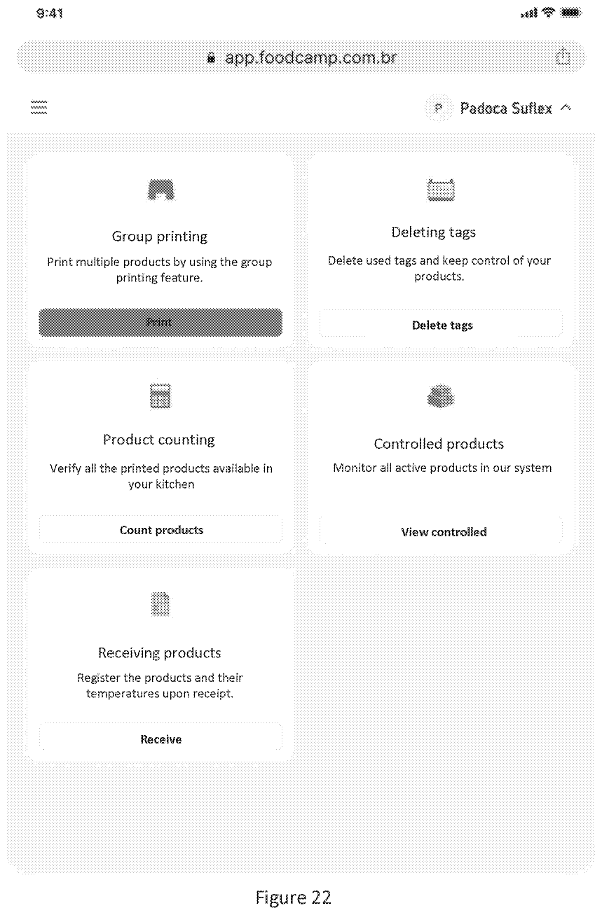

FIGS. 21 and 22 display the system's “home page” screen, which is a user's first entry. The features are arranged as follows: Tags-Expiry Dates Receipt-Counting-Controlled. The registration fields are separated as follows: (Products-Groups-Team ((Employees-employee registration))-Methods) and Settings (Data Settings and Print Point Settings). The last two items are only available to the Manager user, since employee registration can only be done by the manager. This screen allows interaction with all the other system features.

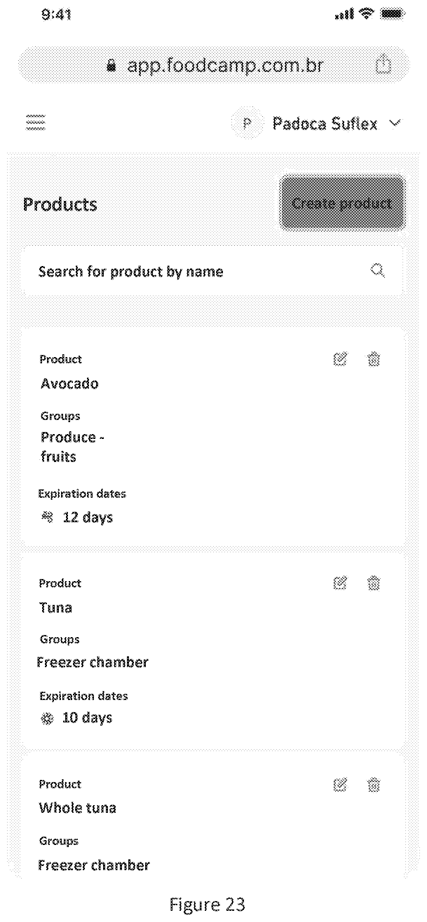

FIG. 23 illustrates the interaction of the Registration screen for registering a new product. This is the environment where all supplies are mapped, and where products are registered that will later become data artifacts upon receipt. Products receive their specification (e.g., Avocado), and are separated into a group (e.g.: Produce-Fruits), receive their suggested expiration date (12 days, for example), indication of product measurement (grammage or liters), indication of brand or supplier, pre-registration of the product's SIF (for items of animal origin), method of counting expiration days (either in days or hours), and method of preservation (for example: cooled, frozen, room temperature, or hot). The user is also able to create custom or personalized statuses to indicate other product transformation processes within the production routine (such as product marinating, product thawing, or desalting process, etc.). In this same environment, it is possible to preview what a printed tag for that product would look like, taking into account a simulation of expiration dates for the day the product is being registered versus when it would expire. After registration, if needed, it is possible to edit the specific artifact for that product or delete it from the product base.

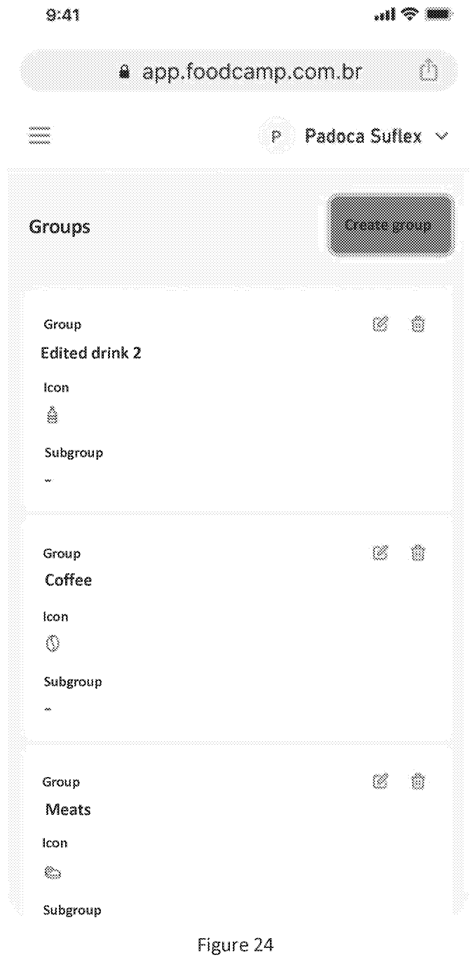

In FIG. 24, it is also possible to create a group for the product on screen (either to categorize-for example, beef proteins; to organize in sites-hot preparation; or to organize into a specific recipe-filet mignon with orange sauce and arugula salad). In this field, it is also possible to create subgroups within groups. Likewise, these groups can be edited and subsequently deleted if necessary. In addition to the registration field, the platform offers a settings environment, which includes: generating a UAN registration, where basic registration data such as name, company name, Corporate Taxpayers Register, and address are input; and visualization of the current print points (PDIs) with the necessary machinery, such as printers and attached microcomputers

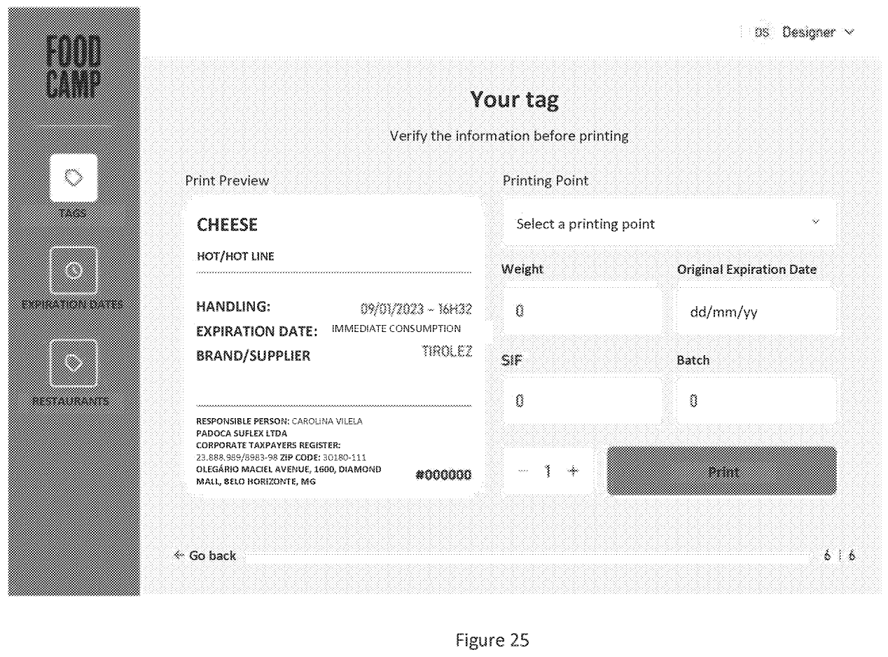

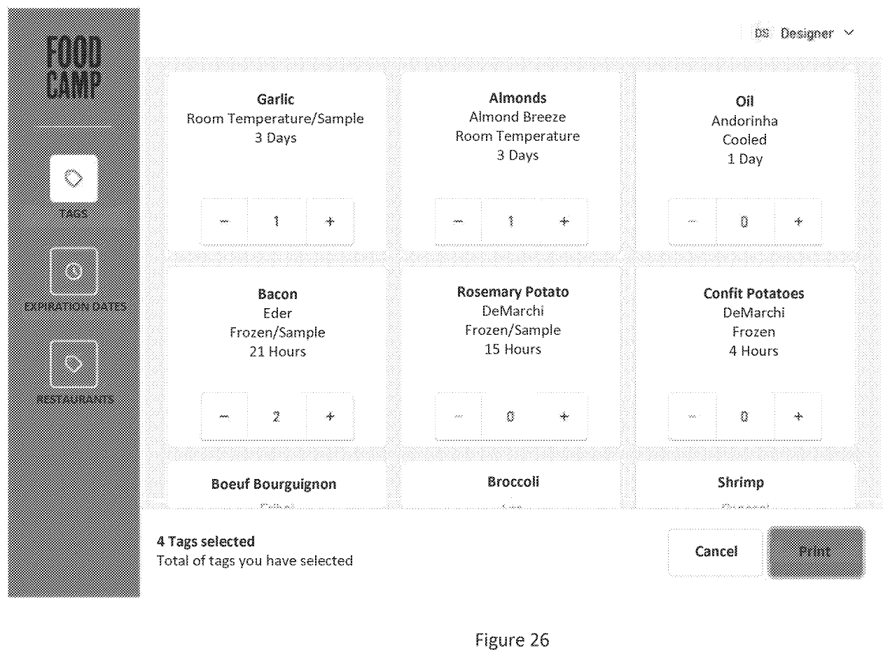

Once the registration process is done, the tag printing workflow becomes possible and consequently the product can be tagged. The user will select the item for which they wish to print the tag and the current storage method for the item. Based on this, the system generates a preview of how the tag will be printed, and the user can select, if applicable, which of the UAN's PDIs they want to print. FIG. 25 displays how it is possible to print a group of tags (as detailed in the previous item) and select all the items that make up the group or select specific items from the group for tag printing. FIG. 26 illustrates this feature, which is aimed at situations where a user needs to tag several items within a group such as, for example, when several supplies are handled simultaneously in a site and need to be tagged.

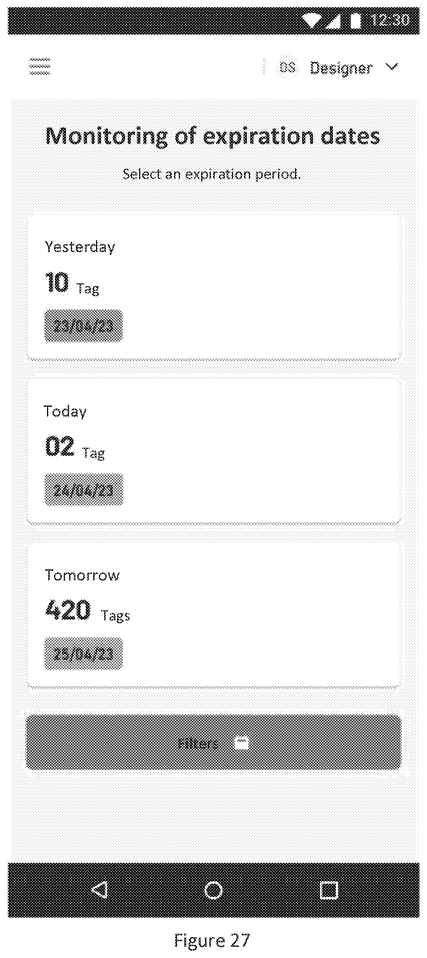

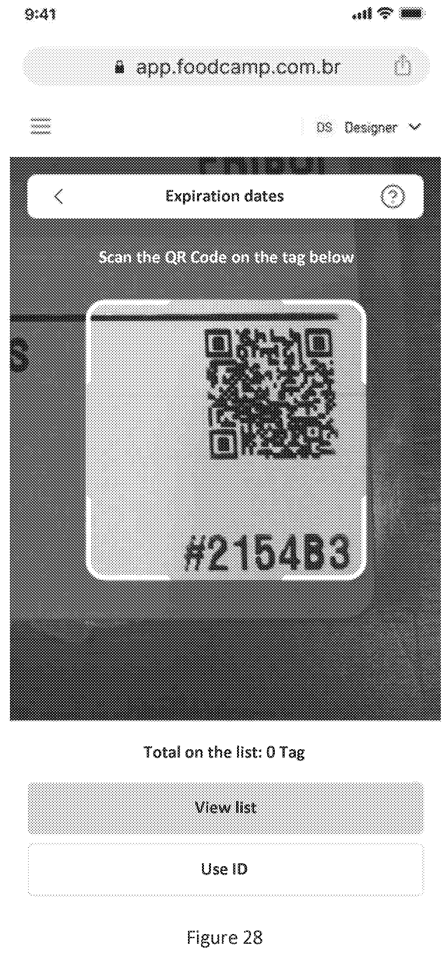

With the completion of the tag printing process, the performance flow moves to the expiration date monitoring and control stage, where the user can view the supply stock from a comprehensive perspective, comprising periods of their choosing. According to FIG. 27, the system indicates tags (supplies) that are considered expired according to their expiration dates, those expiring on the current day, and those that will expire soon. If needed, the user will be able to create time filters to analyze different periods, such as weeks, months, or specific time frames. FIG. 28 displays the monitoring environment, where the user can delete tags and contribute to increasing the reliability index of the system removed tags are not integrated into the data mesh of this monitoring system and, therefore, the more proactive the user is in removing them from the system, the better the purity of the data contained in this monitoring screen becomes, which translates into a greater capacity to act on the data gathered herein.

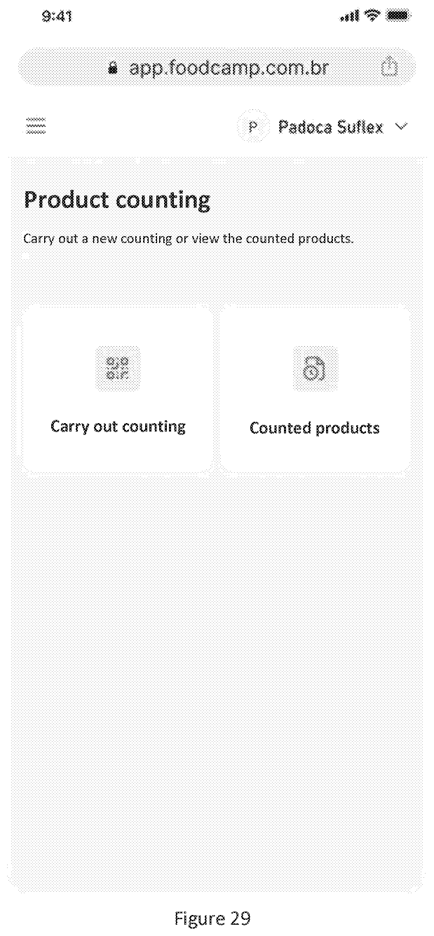

FIG. 29 displays the screen that allows for counting the supplies in stock at the UAN. At the conclusion of this counting process, the user can verify the products scanned and search for products by name (if they want to view a specific product to ensure that it was scanned), finalize the count, or add more products if necessary. Subsequently, the user will be able to verify the list of products counted in the previous step for active monitoring and two-step verification purposes, to ensure mitigation of operational risks in counting.

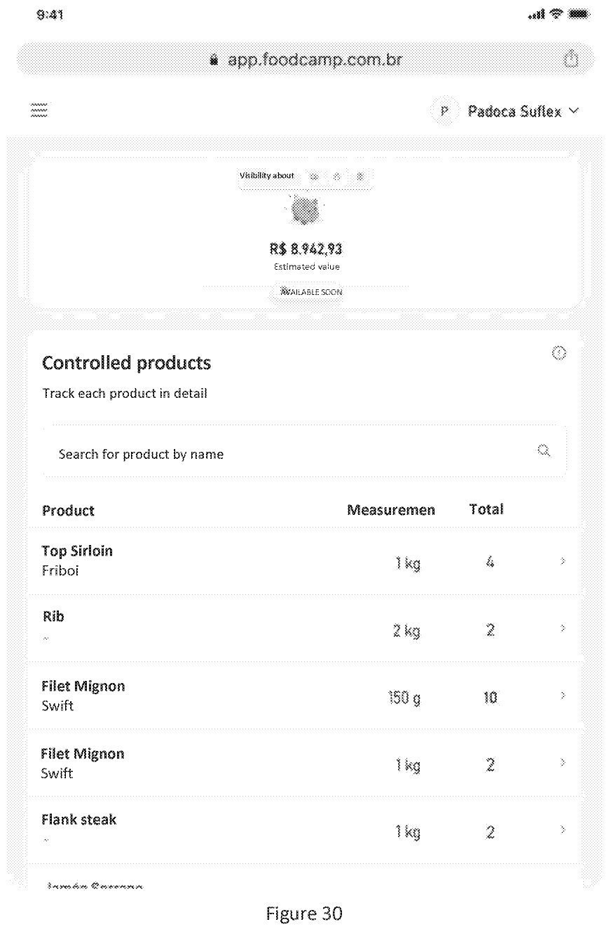

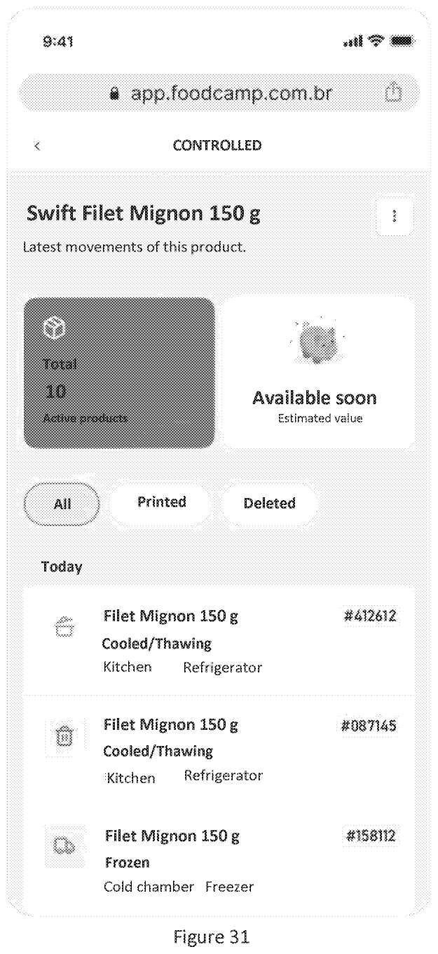

FIG. 30 displays the “Controlled” environment, in which the system compares counted products against products that are registered as “active” in the system because they are tagged. This environment best reflects the reliability of the system due to proactive user interaction. On this screen, the user can view the pecuniary value of the supplies and processed items that are effectively in the kitchen (from the whole chicken that has just been received to the fractionated chicken that is being handled). Finally, this control field shows the status of the supplies and allows an accurate picture (if the user has been diligent in filling it out and interacting with the platform) of the current state of the supplies in the kitchen. They are able to visualize how many instances of supplies they have in the kitchen at the time of receipt, at the time of printing, and at the time of deletion, which reflects the transformation of the supply into a product intended for the final consumer or the end of its expiration date, according to FIG. 31.

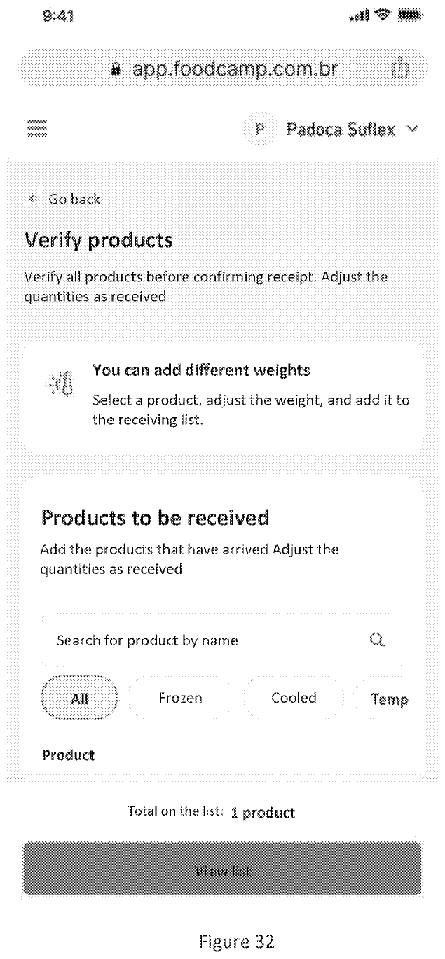

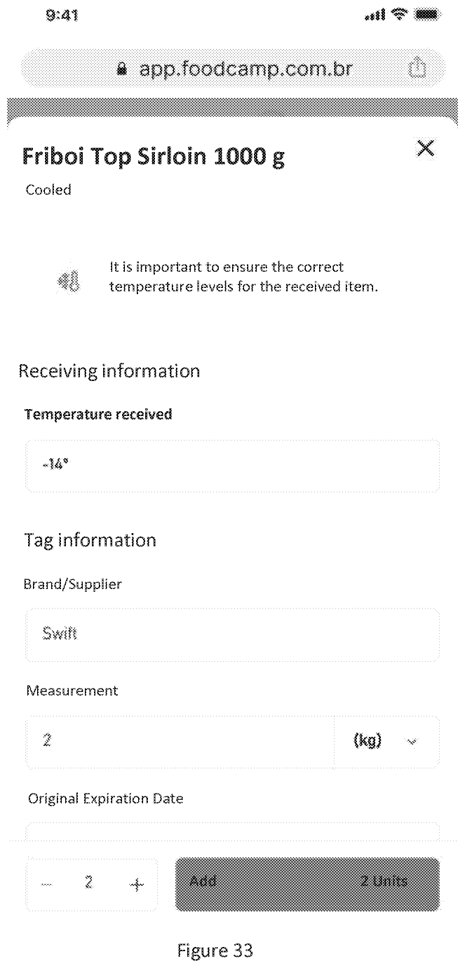

FIG. 32 refers to the receiving feature, where the user can control products that are being added to the stock in a purchase and/or restocking process. This interface utilizes the abovementioned product registration artifacts for supplies entering the stock, and it is at this time that the user will verify the temperature, quality, and quantity of the supply upon receipt in the kitchen, as can be seen in FIG. 33.

It is observed that the system of the present invention enables complete control of supplies in a UAN in terms of quantity, quality, storage, fractionating, expiration date, pecuniary value, and compliance with current health surveillance regulations. In this respect, it is important to emphasize that if the system is used outside of Brazil, it can connect to or be fed with a database of relevant local regulations and legislation to ensure compliance with all applicable rules.

It is also important to highlight that said system can be used to control stocks that are physically separated, such as, for example, those stored in different environments of the same building, or even those stored in different buildings, such as, for example, in two units of the same restaurant.

Furthermore, the user can contract and use the system of the present invention in customizable packages to adapt its use to their needs and financial possibilities without thereby departing from the scope of protection claimed herein. Similarly, the system screens can be customized based on the products handled by the UANs and/or adapted to usage needs, such as a screen for storing images of invoices for products acquired and received by the UAN, to enable for even more comprehensive control of the entire process involving food supplies in the establishment.

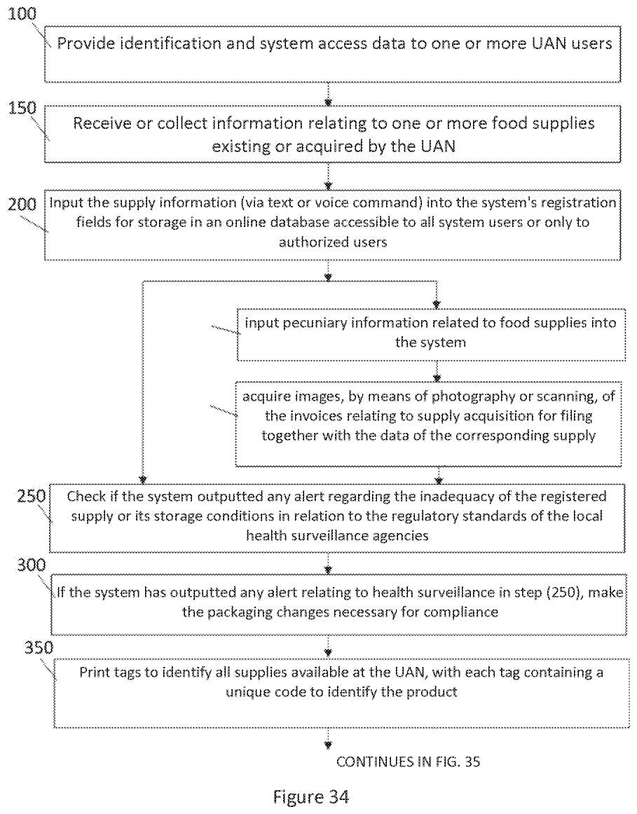

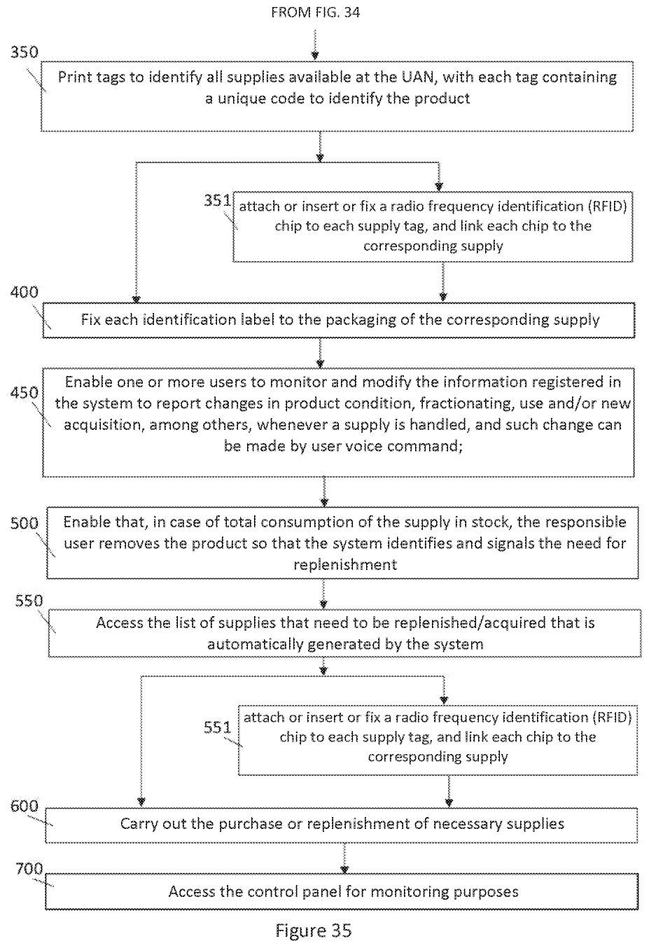

Finally, the method for managing food supply production according to the present invention comprises the following steps, as illustrated in FIGS. 34 and 35:
(100) provide identification and system access data to one or more UAN users;
(150) receive or collect information relating to one or more food supplies existing or acquired by the UAN;
(200) input supply information into system registration fields and thus store said information in an online database that may be accessible to all system users or only to authorized users such as, for example, the manager, and such input may be made by user voice command;
(201) optional step: input into the system pecuniary information relating to food supplies such as, e.g., total acquisition value or value per unit, weight and/or volume;
(202) optional step: acquire images, by means of photography or scanning, of the invoices relating to supply acquisition for filing together with the data of the corresponding supply;
(250) check if the system outputted any alert regarding the inadequacy of the registered supply or its storage conditions in relation to the regulatory standards of the local health surveillance agencies;
(300) if the system has outputted any alert relating to health surveillance in step (250), make the packaging changes necessary for compliance;
(350) print tags for identification of all supplies available in the UAN, each tag containing a unique code for product identification and information such as name, manufacturer and/or supplier data, quantity (units, weight or volume), expiration date, handling date, responsible user, UAN data and product status;
(351) optional step: attach or insert or fix a radio frequency identification (RFID) chip to each supply tag, and link each chip to the corresponding supply, for later control by specific readers;
(400) fixing each identification tag to the packaging of the corresponding supply;
(450) enable one or more users to monitor and modify the information registered in the system to report changes in product condition, fractionating, use and/or new acquisition, among others, whenever a supply is handled, and such change can be made by user voice command;
(500) enable that, in case of total consumption of the supply in stock, the responsible user removes the product so that the system identifies and signals the need for replenishment;
(550) access the list of supplies that need to be replenished/acquired that is automatically generated by the system;
(551) optional step: authorize the system to automatically send a message to the supplier of the supply that needs to be acquired to place the purchase order in the quantity previously registered in the system;
(600) carry out the purchase or replenishment of necessary supplies; and (700) optional step: access, whenever necessary, a control panel containing the entire history of user registers and interactions in the system, for the purpose of monitoring, reviewing or outputting listings of supplies in stock, supplies about to expire, expired supplies, supplies to be acquired, analysis of the quantity of supplies in pecuniary value, among others. Such access may be granted to all system users or, alternatively, only to UAN managers.

### Final Remarks

The present invention describes a method and system for managing food supply production which solves all the disadvantages of the state of the art, in addition to enabling more comprehensive, effective, practical, and economical management for the control of supplies in UANs.

### Conclusion

It will be readily understood by a person skilled in the art that modifications may be carried out herein without departing from the concepts set out in the description above. Such modifications should be considered as comprised within the scope of the present invention. Consequently, the particular embodiments previously described in detail are illustrative and exemplary only and are non-restrictive as to the scope of the present invention, to which the full extent of the appended claims and any and all equivalents thereof should be given.

1. A system for managing food supply production for food and nutrition units “UANs”, characterized in that it comprises:
at least one electronic device for executing management operations of food supplies, including processing, storing, updating, and transmitting data relating to food supplies;
at least one image capture device cooperating with said electronic device, and
at least one tag printing device connected, remotely or via wire, to said electronic device,
wherein each tag comprises four sections (1, 2, 3, and 4), wherein section (1) presents the product name (11), the measurement unit (12), and the storage condition (13), section (2), located in the middle region of the tag, presents information relating to properties of the food supplies aimed at complying with local regulatory and health obligations, section (3), located in the lower region of the tag, indicates the responsible user (31) and the business information (32) of the UAN, section (4) presents an identifier number for the food supply and/or a reading code (5) generated by a system algorithm, wherein the information from each section (1, 2, 3, and 4) are located separately and hierarchically on the tag, and the system enables dynamic updating of the information linked to the tag through integration with a cloud database, also enabling modulation of the physical size of the tag and customization of the informational fields according to the user's setting;
wherein the information in each section (1, 2, 3, and 4) are separately and hierarchically organized on the tag according to the Principle of Common Region, the Principle of Proximity, the Principle of Pragnanz, the Principle of Similarity, and the Principle of Uniform Connectedness;
wherein said management system sends and receives information packages from at least one database stored in digital cloud;
wherein the system enables dynamic updating of information linked to the tag through integration with the database stored in digital cloud; and
wherein at least one information package provides information that enables the system to check whether food supplies comply with local regulatory and health obligations.

2. The system, according to claim 1, characterized in that the printing device comprises printing reading codes, which can be one of a barcode or a QR code.

3. The system, according to claim 1, characterized in that the system will output an alert when it identifies any food supply that does not comply with local regulatory and health obligations.

4. The system, according to claim 1, characterized in that the system comprises means for the user to define the size of the tags and the additional information that said tags may contain, wherein such additional information can be at least one of the visual identification of the UAN, the name of the UAN, and the address of the UAN.

5. A method for managing food supply production, executed through a system for managing supply production for food and nutrition units according to claim 1, characterized in that the method comprises the following steps:
(100) providing identification and system access data to one or more users of the food and nutrition unit;
(150) receiving or collecting information relating to one or more food supplies existing or acquired by the food and nutrition unit;
(200) inputting supply information into system registration fields;
(250) checking if the system outputted any alert regarding the inadequacy of the registered supply in relation to the standards of the local health surveillance agencies;
(300) if the system outputted any alert in step (250), making the necessary changes to regularize the inadequate supply;
(350) printing identification tags containing information relating to each of the supplies available in the food and nutrition unit, each tag containing a unique code for product identification;
(400) fixing each identification tag to the packaging of the corresponding supply;
(450) monitoring and modifying the information registered for each supply in the system whenever there is a change in the product condition, fractionating, use and/or new acquisition, among others, whenever a supply is handled;
(500) in case of total consumption of the supply, removing the supply from the system so that the system registers and signals the need to replenish the supply;
(550) accessing the list of supplies that need to be replenished or acquired, which is automatically generated by the system; and
(600) carrying out the purchase or replenishment of necessary supplies.

6. The method, according to claim 5, characterized in that it further comprises step (201) of inputting pecuniary information relating to food supplies into the system.

7. The method, according to claim 5, characterized in that it further comprises step (202) of acquiring images of the supply acquisition invoices for filing together with the corresponding supply data.

8. The method, according to claim 5, characterized in that it further comprises step (351) of attaching, fixing, or inputting, in each supply tag, at least one radio frequency identification (RFID) chip, and linking each chip to the corresponding supply.

9. The method, according to claim 5, characterized in that it further comprises step (551) of automatically sending a message from the system to a supplier of a supply which needs to be acquired, in order to place a purchase order for the supply in the quantity previously registered in the system.

10. The method, according to claim 5, characterized in that it further comprises step (700) of accessing a control panel containing the entire history of user registers and interactions in the system, for the purpose of monitoring, reviewing, or outputting listings relating to supplies.

11. The method, according to claim 5, characterized in that the inputting or updating of information relating to supplies in the system is carried out via voice command.
